(19) United States
(12) Patent Application Publication
(10) Pub. No.: US 2006/0271670 A1
(43) Pub. Date: Nov. 30, 2006

(54) System and method for partitioning network analysis

(76) Inventors: Scott A. Blomquist, Colorado Springs, CO (US); John M. Monk, Monument, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/139,563

(22) Filed: May 31, 2005

(51) Int. Cl. G06F 15/173

(52) U.S. Cl. 709/224

(57) ABSTRACT

A system includes a plurality of distributed network analyzers, each of the distributed network analyzers configured to receive and filter network traffic from a single network link under test so that the network traffic is distributed across the plurality of distributed network analyzers and to capture data from the filtered network traffic. The system also includes a processing device receiving the captured data from the each of the plurality of distributed network analyzers, wherein the processing device includes software configured to interleave the received data to form a single stream of data from network traffic on the network link under test.

### BACKGROUND OF THE INVENTION

Distributed network analyzers (DNAs) are used to passively monitor and analyze data from links in a network link under test. Generally, as shown in FIG. 1, DNAs 100₁, . . . , 100ₙ use line interface modules (LIMs) 110₁, . . . , 110ₙ to connect to multiple links in network link under test (NUT) 120. Different LIMs can allow the same DNA to connect to different networks using different network interface protocols, such as 10/100 Ethernet, OC-3, and T1/E1. Referring now to FIG. 1, which illustrates a conventional network monitoring system in which multiple links in a NUT are monitored simultaneously, when connected to links in NUT 120 via LIMs 110₁, . . . , 110ₙ, DNAs 100₁, . . . , 100ₙ stream data to a computer 130 using, for example, an Ethernet link using TCP/IP. Signal analysis software is then used to time interleave and analyze the streamed data.

In some applications, such as cellular phone networks, it is preferable to have a single higher speed link, such as an OC-3 or OC-12 line, rather than several aggregated lower speed links, such as T1 lines. Applications in which a single higher speed link may be preferable, such as Universal Mobile Telephone System (UMTS) or Code Division Multiple Access 2000 (CDMA2000) networks, require higher performance solutions for monitoring a single network link under test. Streaming data from a single DNA monitoring a network link under test can be too constraining for some applications, as the transfer speed from a DNA to a computer is limited. Thus, there is a need for higher performance monitoring of a single network link under test.

For example, in an attempt to provide a higher performance solution for monitoring a network link under test, some network monitoring systems stream data from a network interface to a disk for storage and later analysis of the stored data. However, depending on the system architecture, the scalability of such a system may be limited.

When monitoring networks requiring higher performance monitoring, it is desirable to capture and stream data at higher rates of speed. It is also desirable to have a modular, scalable solution that can be easily and cost-effectively adapted as the network changes. Further, it is cost-effective to reuse components, such as distributed network analyzers, that may currently be in use. Additionally, it is desirable that the monitoring system be readily adaptable for use with a variety of network interface protocols.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 (Prior Art) is a diagram illustrating a conventional system for monitoring a network under test;

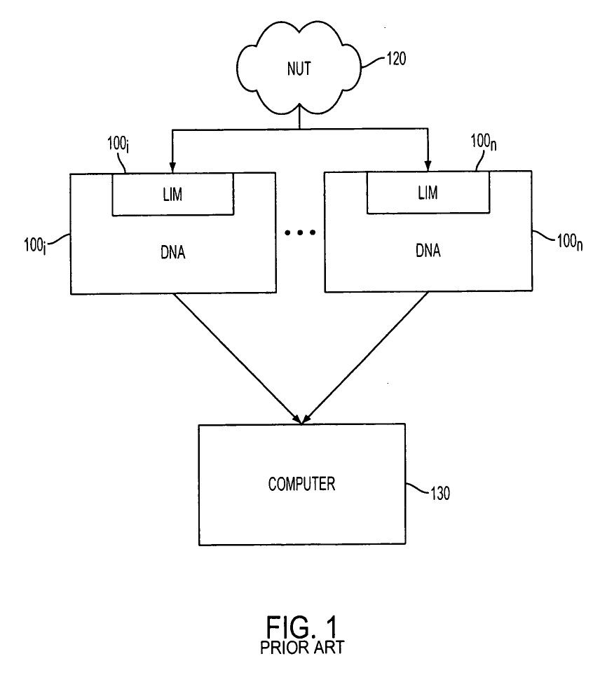

FIG. 2 is a block diagram illustrating a system for partitioning network analysis, according to an embodiment of the present invention;

FIG. 3 is a block diagram illustrating a system for partitioning network analysis, according to another embodiment of the present invention; and

FIG. 4 is a flow chart illustrating a method for partitioning network analysis.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

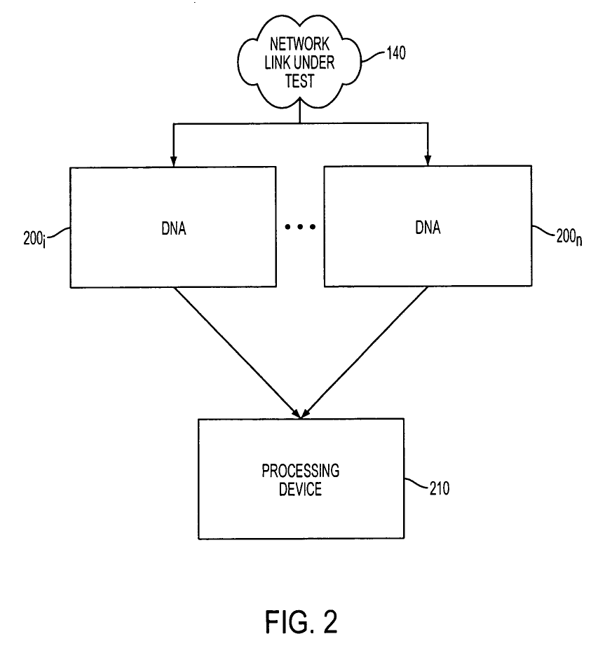

FIG. 2 is a block diagram illustrating a system for partitioning network analysis, according to an embodiment of the present invention. Referring to FIG. 2, network link under test 140 is monitored using a plurality of distributed network analyzers (DNAs) 200₁, . . . , 200ₙ. For example, the DNAs used in the present invention may be Agilent Technologies, Inc. model number J6801A distributed network analyzers. However, the present invention is not limited to using any specific model of distributed network analyzers. The DNAs may be time synchronized, however, this is not required. Time synchronization ensures that the plurality of DNAs monitor network traffic for the same time intervals and also allows time ordered interleaving of the frames or cells collected from multiple DNAs. Time synchronization may be achieved, for example, via Global Positioning System (GPS), network time protocol (NTP), or proprietary Control & Sync ports, but is not limited to these means of achieving synchronization.

Although not shown in FIG. 2, the present invention may include a line interface module (LIM) corresponding to each DNA. However, a LIM is not required. The present invention is not limited to any particular type of LIM, and any LIM configured to connect a DNA to the network link under test 140 for analysis may be used.

Each of the DNAs 200₁, . . . , 200ₙ is configured to receive network traffic from network link under test 140. Network traffic may be distributed by, for example, using an optical splitter, daisy chaining the signal through a LIM, or using multiple “span ports” or “mirror ports” off of a network switch. However, the present invention is not limited to these means of distribution of network traffic, and any means of distributing network traffic may be used.

Additionally, each of DNAs 200₁, . . . , 200ₙ is configured to filter network traffic from network link under test 140, such that each of DNAs 200₁, . . . , 200ₙ sees only a fraction of the network traffic received from network link under test 140 using, for example, a capture filter. For example, when monitoring an Internet Protocol (IP) network on Ethernet, each DNA may be configured to filter out all but a specific set of IP addresses. The DNAs 200₁, . . . , 200ₙ may also be configured so that each of the plurality of DNAs receives and filters an exclusive subset of network traffic. However, the present invention is not limited to any specific type of filtering and any type of filtering which distributes the network traffic across a plurality of DNAs may be used.

Each of the DNAs 200₁, . . . , 200ₙ is also configured to capture data from the network traffic received. Each of DNAs 200₁, . . . , 200ₙ then streams the captured data to a processing device 210, which receives the streams of captured data.

The processing device 210 includes software configured to interleave the received data to form a single stream of data from the network traffic from the network link under test 140. Processing device 210 may be, for example, a personal computer or server. However, processing device 210 is not limited to these types of processing devices and may be any type of processing device. Software running on processing device 210 is used to interleave the received data. The data may be interleaved, for example, based on time ordering using time stamp information recorded with each frame when it is captured by the DNA. However, the present invention is not limited to interleaving data based on time ordering and any method of interleaving data may be used. The software used to accomplish this may be, for example, the Agilent Technologies, Inc. J7830A Signaling Analyzer Real-Time Edition (SART) software. However, the present invention is not limited to Agilent's SART software and may be any software suitable for accurately interleaving data to form a single stream of data from a plurality of streams of data.

The software may also perform analysis on the data. The analysis performed by the software may include call trace analysis or statistical analyses of the data captured. The analysis performed by the software is, however, not limited to these types of analysis and may be any type of analysis for which the software is configured. The interleaved data may also be stored for later analysis.

Each of the DNAs 200₁, . . . , 200ₙ may also perform statistical analysis on the network traffic received and captured by the DNA. The statistical analysis performed may be any type of network analysis and is not limited to any specific statistics. The results of each statistical analysis are then streamed to processing device 210, which receives results of each of the statistical analyses. Software, such as SART software, may then be used to merge the received results of the statistical analyses. The software, however, is not limited to SART software and may be any type of software capable of merging the received results of the statistical analyses performed. Thus, a single, comprehensive set of statistical data can be created for a network link under test monitored by a plurality of DNAs.

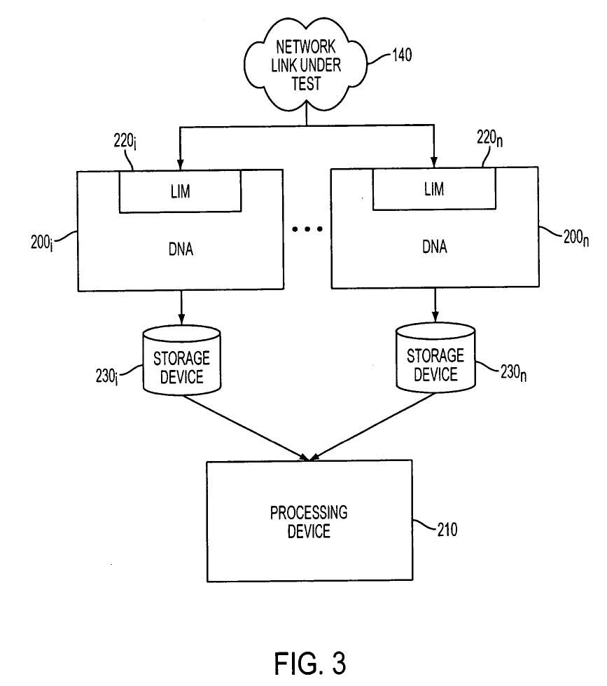

FIG. 3 is a block diagram illustrating a system for partitioning network analysis, according to another embodiment of the present invention. Referring to FIG. 3, network link under test 140 is monitored using a plurality of distributed network analyzers (DNAs) 200₁, . . . , 200ₙ. The DNAs may be time synchronized, but this is not required. Time synchronization ensures that the plurality of DNAs monitor network traffic for the same time intervals and also allows time ordered interleaving of the frames or cells collected from multiple DNAs. Time synchronization may be achieved, for example, via Global Positioning System (GPS), network time protocol (NTP), or proprietary Control & Sync ports, but is not limited to these means of achieving synchronization. Although not shown in FIG. 3, the present invention may include a line interface module (LIM) corresponding to each DNA. However, a LIM corresponding to each DNA is not required. Further, the present invention is not limited to any particular type of LIM, and any LIM configured to connect a DNA to the network link under test 140 for analysis may be used.

Each of the DNAs 200₁, . . . , 200ₙ is configured to receive network traffic from network link under test 140. Network traffic may be distributed by, for example, using an optical splitter, daisy chaining the signal through a LIM, or using multiple “span ports” or “mirror ports” off of a network switch. However, the present invention is not limited to these means of distribution of network traffic, and any means of distributing network traffic may be used.

Additionally, each of DNAs 200₁, . . . , 200ₙ is configured to filter network traffic from network link under test 140, such that each of DNAs 200₁, . . . , 200ₙ sees only a subset of the network traffic received from network link under test 140 using, for example, a capture filter. For example, when monitoring an Internet Protocol (IP) network on Ethernet, each DNA may be configured to filter out all but a specific set of IP addresses. The DNAs 200₁, . . . , 200ₙ may also be configured so that each of the plurality of DNAs receives and filters an exclusive subset of network traffic. However, the present invention is not limited to any specific type of filtering and any type of filtering which distributes the network traffic across a plurality of DNAs may be used.

Each of the DNAs 200₁, . . . , 200ₙ is also configured to capture data from the network traffic received. Each of DNAs 200₁, . . . , 200ₙ then streams the captured data to their respective data storage device 230₁, . . . , 230ₙ. Each data storage device 230₁, . . . , 230ₙ then stores the data captured by the corresponding DNA. Thus, the captured data is partitioned across multiple data storage devices. Data storage devices 230₁, . . . , 230ₙ may be, for example, hard disk drives, a Network Attached Storage Device (NAS) or a Storage Area Network (SAN). However, the present invention is not limited to using any type of disk drive and any storage medium may be used. Alternatively, each DNA could store the captured data to its own disk, or the DNAs could store the captured data to shared disks.

Data stored in each of data storage devices 230₁, . . . , 230ₙ is then read by a processing device 210 which may be, for example, a personal computer or server. However, processing device 210 is not limited to these types of processing devices and may be any type of processing device. Software running on processing device 210 then interleaves the received data. The data may be interleaved, for example, based on time ordering using time stamp information stored in each frame as it is captured by the DNA. However, the present invention is not limited to interleaving data based on time ordering and any method of interleaving data may be used. The software used to accomplish this may be, for example, may be Signaling Analyzer Real-Time Edition (SART) software. However, the present invention is not limited to SART software and may be any software suitable for accurately interleaving data to form a single stream of data from a plurality of streams of data.

The software may also perform analysis on the data. The analysis performed by the software may include call trace analysis or statistical analyses of the data captured. The analysis performed by the software is, however, not limited to these types of analysis and may be any type of analysis for which the software is configured. The interleaved data may also be stored for later analysis.

Each of the DNAs 200₁, . . . , 200ₙ may also perform statistical analysis on the network traffic received and captured by the DNA. The statistical analysis performed may be any type of network analysis and is not limited to any specific statistics. The results of each statistical analysis are then streamed to the respective data storage device 230₁, . . . , 230ₙ, which receives results of each of the statistical analyses from the plurality of data storage devices 230₁, . . . , 230ₙ. This stored data may then be streamed to processing device 210.

Software running on processing device 210, such as SART software, may then be used to merge the received results of the statistical analyses. The software, however, is not limited to SART software and may be any type of software capable of merging the received results of the statistical analyses performed. Thus, a single, comprehensive set of statistical data can be created for a network link under test monitored by a plurality of DNAs.

In an alternative embodiment of the present invention, the DNAs 200₁, . . . , 200ₙ may only perform statistical analysis on the incoming network traffic and may not capture data from the incoming network traffic.

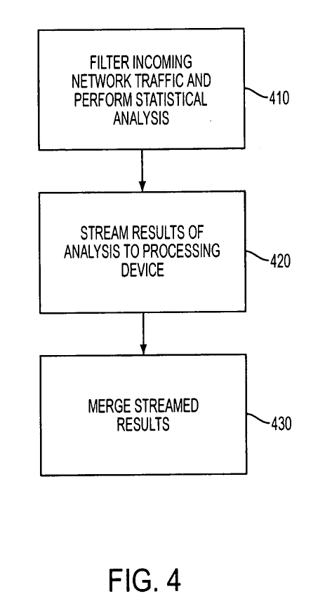

FIG. 4 is a flow chart illustrating a method for partitioning network analysis. In operation 410, a plurality of DNAs is used to filter incoming network traffic, and each DNA performs a statistical analysis on the incoming network traffic that it does not filter out. In operation 420, the results of the statistical analyses are streamed from the plurality of DNAs to a processing device. In operation 430, the results of the statistical analyses are merged to create a single, comprehensive set of statistical information regarding all of the incoming network traffic.

For example, if node statistics were to be analyzed, multiple DNAs would be used to monitor the same network segment (link). Each DNA would be configured to capture a mutually exclusive subset of the traffic on the link using, for example, capture filters. Each DNA would then compute a node statistics table for its subset of the traffic monitored during a synchronized time interval. Time synchronization ensures that all of the DNAs compute node statistics tables for the same time intervals. Time synchronization may be achieved, for example, via Global Positioning System (GPS), network time protocol (NTP), or proprietary Control & Sync ports, but is not limited to these means of achieving synchronization. These node statistics tables would then be merged to provide a comprehensive node statistics table for the network segment (link). However, the network statistics analyzed by the DNA are not limited to node statistics and may be any type of network statistics.

Further, the plurality of DNAs may also be used to capture data from the incoming network traffic that is not filtered out. These results may then be streamed from the plurality of DNAs to the processing device, where the data is interleaved. The interleaving may be based on time, but is not limited to interleaving based on time.

Additionally, the interleaved data can be analyzed. Examples of analyses which may be performed include call trace and statistical analyses. The interleaved data may also be stored for off-line analysis.

Thus, the present invention provides cost effective means for improved data rates by distributing network traffic from a network link under test across a plurality of distributed network analyzers. Existing DNAs may be used in parallel to monitor mutually exclusive subsets of traffic on the same network segment (link). As the network traffic is distributed across a plurality of DNAs, network traffic can be analyzed more quickly. If additional speed is desired, additional DNAs can be introduced to the system to process subsets of network traffic, reducing the load on each DNA so that the same amount of network traffic can be analyzed in less time. Thus, the system of the present invention is both modular and scalable.

Various protocols and standards have been described herein. However, the present invention is not limited to any specific protocols and/or standards.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A system comprising:
a plurality of distributed network analyzers, each of the distributed network analyzers configured to receive and filter network traffic from a single network link under test so that the network traffic is distributed across the plurality of distributed network analyzers and to capture data from the filtered network traffic; and
a processing device receiving the captured data from the each of the plurality of distributed network analyzers, wherein the processing device includes software configured to interleave the received data to form a single stream of data from network traffic on the network link under test.

2. A system according to claim 1, further comprising a plurality of line interface modules corresponding, respectively, to the plurality of distributed network analyzers, the line interface modules being configured to connect the plurality of distributed network analyzers to the network link under test.

3. A system according to claim 1, wherein each of the plurality of distributed network analyzers receives and filters an exclusive subset of network traffic.

4. A system according to claim 1, wherein the distributed network analyzers are time synchronized.

5. A system according to claim 1, wherein network traffic is filtered using capture filters.

6. A system according to claim 1, wherein
each distributed network analyzer performs statistical analysis on the network traffic,
the processing device receives results of the statistical analysis from each of the distributed network analyzers, and
the software is configured to merge the received results to create a single set of statistical analysis information for the network link under test.

7. A system comprising:
a plurality of distributed network analyzers, each of the distributed network analyzers configured to receive and filter network traffic so that the network traffic is distributed across the plurality of distributed network analyzers and to capture data from the filtered network traffic;
a plurality of data storage devices corresponding, respectively, to the plurality of distributed network analyzers, each data storage device storing captured data received from the corresponding distributed network analyzer; and
a processing device reading stored data from each of the plurality of data storage devices, wherein the processing device includes software configured to interleave the received data to form a single stream of data from network traffic on a network link under test.

8. A system according to claim 7, further comprising a plurality of line interface modules corresponding, respectively, to the plurality of distributed network analyzers, the line interface modules being configured to connect the plurality of distributed network analyzers to the network link under test.

9. A system according to claim 7, wherein each of the plurality of distributed network analyzers receives and filters an exclusive subset of network traffic.

10. A system according to claim 7, wherein the distributed network analyzers are time synchronized.

11. A system according to claim 7, wherein network traffic is filtered using capture filters.

12. A system according to claim 7, wherein
each of the plurality of distributed network analyzers performs statistical analysis on the filtered information,
each of the plurality of data storage devices stores statistical information received from each of the corresponding plurality of distributed network analyzers,
the processing device receives stored statistical information from each of the plurality of data storage devices, and
the software is configured to merge the received statistical information to create a single set of statistical analysis information for the network link under test.

13. A system comprising:
a plurality of distributed network analyzers, each of the network analyzers configured to receive and filter network traffic so that the network traffic is distributed across the plurality of distributed network analyzers and to perform statistical analysis on the filtered network traffic; and
a processing device receiving statistical information from each of the plurality of distributed network analyzers, wherein the processing device includes software configured to merge the received statistical information to form a single set of statistical information for a network link under test.

14. A system according to claim 13, further comprising a plurality of line interface modules corresponding, respectively, to the plurality of distributed network, the line interface modules being configured to connect the plurality of distributed network analyzers to the network link under test.

15. A system according to claim 13, wherein each of the plurality of distributed network analyzers receives and filters an exclusive subset of network traffic.

16. A system according to claim 13, wherein the distributed network analyzers are time synchronized.

17. A system according to claim 13, wherein network traffic is filtered using capture filters.

18. A method comprising:
using a plurality of distributed network analyzers to filter incoming network traffic and to perform statistical analyses on subsets of incoming network traffic;
streaming the results of the statistical analyses performed by each of the plurality of distributed network analyzers to a processing device; and
merging the streamed results.

19. A method according to claim 18, wherein incoming network traffic is filtered using capture filters.

20. A method according to claim 18, further comprising:
using the plurality of distributed network analyzers to capture data from the filtered incoming network traffic;
streaming the captured data to the processing device; and
interleaving the streamed data.
